(19) United States
(12) Patent Application Publication
(10) Pub. No.: US 2015/0220159 A1
(43) Pub. Date: Aug. 6, 2015

(54) SYSTEM AND METHOD FOR CONTROL OF A DEVICE BASED ON USER IDENTIFICATION

(71) Applicant: POINTGRAB LTD., Hod Hasharon (IL)

(72) Inventors: YONATAN HYATT, TEL-AVIV (IL); ASSAF GAD, HOLON (IL)

(21) Appl. No.: 14/613,511

(22) Filed: Feb. 4, 2015

Related U.S. Application Data
(60) Provisional application No. 61/935,348, filed on Feb. 4, 2014.

(51) Int. Cl. G06F 3/01; G06K 9/00

(52) U.S. Cl. CPC G06F 3/017; G06K 9/00288; G06K 9/00255; G06K 9/00335; G06K 9/00355

(57) ABSTRACT

A method and system are provided for computer vision based control of a device which include detecting a user operating the device, determining the user identity based on image information, and personalizing operation of the device based on the determined user identity, and where a home or building appliance may be controlled according to a preferred set of parameters, based on the identity of the user.

### CROSS-REFERENCE TO RELATED APPLICATIONS

This application claims priority from U.S. Provisional Patent Application No. 61/935,348, filed Feb. 4, 2014, the contents of which are incorporated herein by reference in their entirety.

### FIELD OF THE INVENTION

The present invention relates to the field of computer vision based control of electronic devices. Specifically, the invention relates to control of devices based on user identification.

### BACKGROUND

The need for more convenient, intuitive and portable input devices increases as computers and other electronic devices become more prevalent in our everyday life.

Recently, human hand gesturing and posturing has been suggested as a user interface input tool in which a hand movement and/or shape is received by a camera and is translated into a specific command. Hand gesture and posture recognition enables humans to interface with machines naturally without any mechanical appliances. Hand gestures have also been suggested as a method for interacting with home and building appliances such as lighting and HVAC (heating, ventilating, and air conditioning) devices or other environment comfort devices.

Some modern day devices implement biometric authentication as a form of identification and access control. Biometric identifiers may include physiological characteristics such as finger prints and face or retinal pattern recognition and/or behavioral characteristics such as gait and voice.

Biometric authentication is typically used for personalization and in security applications.

Some devices enable secure access (log-on) to personalized menus based on face recognition. These same devices enable control of the device using hand postures and gestures. However, there are no systems that combine the use of biometric identifiers with posture/gesture control, to improve the user's interaction with the device.

### SUMMARY

Methods and systems according to embodiments of the invention enable using the identity of a user to control aspects of a device which are related to posture/gesture control. Thus, methods and systems according to embodiments of the invention enable efficient utilization of posture and/or gesture detection and recognition modules to enable accurate and fast posture/gesture recognition, based on identification of the user.

“Identification (or identity) of a user” may mean profiling or classification of a user (e.g., determining the user's general characteristics such as gender, ethnicity, age etc.) and/or recognition of specific user features and recognition of a user as a specific user.

Additionally, embodiments of the invention enable easy and simple personalized control of devices, providing a more positive user experience and enabling efficient operation of environment comfort devices. In one embodiment a method for controlling a device includes the steps of recognizing a shape (e.g., a shape of a user's hand) within a sequence of images; generating a command to control the device based on the recognized shape; determining the user identity from the image; and personalizing the command to control the device based on the user identity.

This way identification of a user is initiated by recognition of a shape (e.g., a shape of a hand). In one embodiment a user is identified to enable personalization only once a shape of a hand (optionally, a pre-determined shape of a hand) is recognized. Since shape recognition uses less computing power than face recognition, embodiments of the invention offer a more efficient method than trying to identify a user in every (or many) frame in order to enable personalized control of a device.

In another embodiment a device such as a home or building appliance may be activated based on recognition of a hand gesture or posture but parameters of the device operation (such as volume, temperature, intensity etc.) may be controlled according to the user identity.

According to one embodiment a detector of hand postures and/or gestures is controlled based on the identity of a user such that posture/gesture detection algorithms may be run or adjusted in accordance with, for example, the skill of the user, thereby utilizing posture/gesture detectors more efficiently.

### BRIEF DESCRIPTION OF THE FIGURES

The invention will now be described in relation to certain examples and embodiments with reference to the following illustrative figures so that it may be more fully understood. In the drawings:

FIGS. 1A and 1B are schematic illustrations of systems according to embodiments of the invention;

FIGS. 2A and B schematically illustrate methods for machine vision based control of a device, according to embodiments of the invention;

FIGS. 3A and 3B schematically illustrate methods for machine vision based control of a device, based on identification of a user, according to embodiments of the invention; and

FIG. 4 schematically illustrates a method for machine vision based control of a device when a hand and face are determined to belong to a single user, according to embodiments of the invention.

### DETAILED DESCRIPTION

Embodiments of the present invention provide computer vision based control of a device which is dependent on the identity of a user. According to some embodiments the identity of the user may be determined based on recognition of the user's postures and/or gestures.

Methods according to embodiments of the invention may be implemented in a system which includes a device configured to be controlled by signals that are generated based on user hand shapes (i.e., hand postures) and/or hand movement, usually in a typical or predetermined pattern (i.e., hand gestures). The system further includes an image sensor which is in communication with a processor. The image sensor obtains image data (typically of the user) and sends it to the processor to perform image analysis and to generate user commands to the device based on the image analysis, thereby controlling the device based on computer vision.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

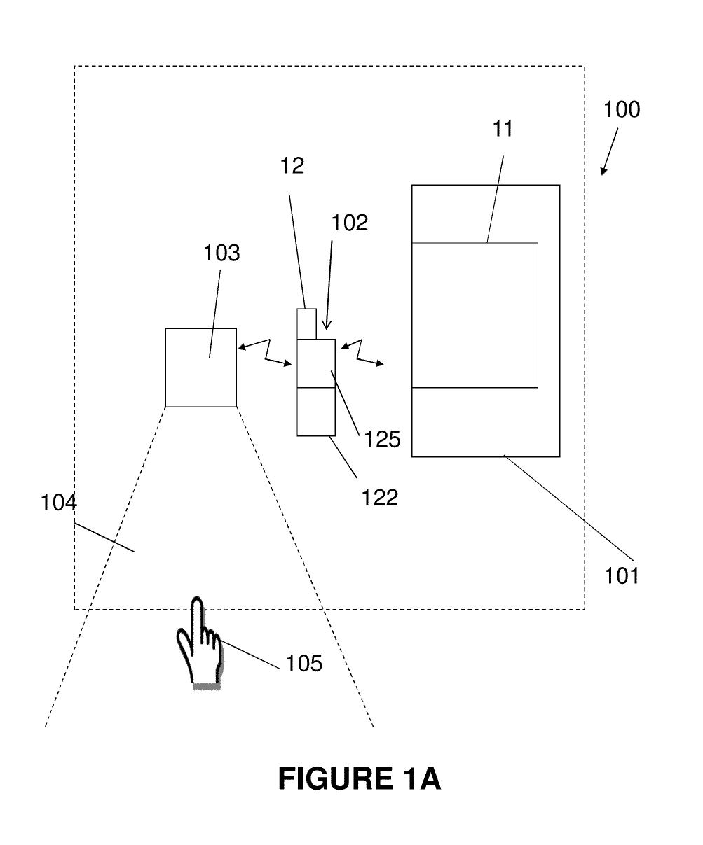

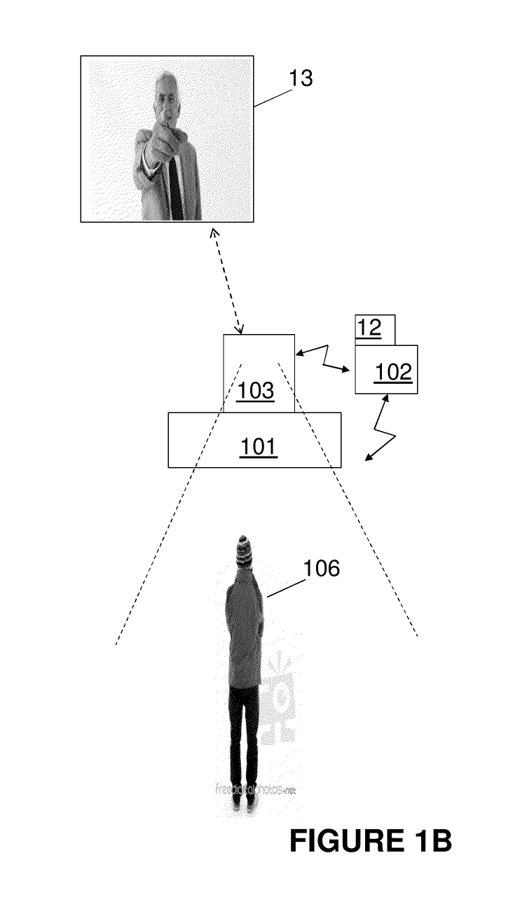

Exemplary systems, according to embodiments of the invention, are schematically described in FIGS. 1A and 1B however other systems may carry out embodiments of the present invention.

In FIG. 1A the system 100 may include an image sensor 103, typically associated with a processor 102, memory 12, and a device 101. The image sensor 103 sends the processor 102 image data or information of field of view (FOV) 104 (the FOV including at least a user's hand 105 and according to some embodiments at least a user's face or part of the user's face) to be analyzed by processor 102. Typically, image signal processing algorithms and/or shape detection or recognition algorithms may be run in processor 102.

Processor 102 may include a posture/gesture detector 122 to detect a posture and/or gesture of a user's hand 105 from an image and to control the device 101 based on the detected posture/gesture, and a user identifying component 125 to determine the identity of a user from the same or another image and to control the posture/gesture detector 122 and/or to control the device 101 based on the identity of the user.

Processor 102 may be a single processor or may include separate units (such as detector 122 and component 125) and may be part of a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

According to one embodiment the processor (e.g., the user identifying component 125) runs algorithms for determining a user identity from an image of the user, for example, face detection and/or recognition algorithms. “User identity” may mean profiling or classification of a user (e.g., determining the user's general characteristics such as gender, ethnicity, age etc.) and/or recognition of specific user features and recognition of a user as a specific user.

According to some embodiments image processing is performed by a first processor which then sends a signal to a second processor in which a command is generated based on the signal from the first processor.

Processor 102 (and/or processors or detectors associated with the processor 102) may run shape recognition algorithms (e.g., in posture/gesture detector 122), for example, an algorithm which calculates Haar-like features in a Viola-Jones object detection framework, to detect shapes (e.g., a hand shape) and to control of the device 101 based on the detection of, for example, hand postures and/or gestures (e.g., to generate a signal to activate device 101 based on the detection of specific hand postures and/or gestures).

According to one embodiment the processor (e.g. posture/gesture detector 122) may recognize a shape of the user's hand and track the recognized hand. Tracking the hand may include verifying the shape of the user's hand during tracking, for example, by applying a shape recognition algorithm to recognize the shape of the user's hand in a first frame and updating the location of the hand in subsequent frames based on recognition of the shape of the hand in each subsequent frame.

According to embodiments of the invention processor 102 may also run face recognition algorithms (e.g., in user identifying component 125) to detect general characteristics such as gender, age, ethnicity, emotions and other characteristics of a user and/or to identify a specific user.

Image information (e.g., features typically used for classification in computer vision) may be used by the processor (e.g., by user identifying component 125) to identify a user. According to one embodiment image information may be saved in a database constructed off-line and may then be used as machine learning classifiers to identify features collected on-line to provide profiling or classification of users. Image information collected on-line may also be used to update the database for quicker and more accurate identification of users.

Image information may also be used to identify user specific information such as facial features of the user.

A user may be identified by techniques other than face recognition (e.g., by voice recognition or other user identification methods). Thus, user identifying component 125 may run voice recognition or other biometric recognition algorithms.

In one embodiment the user identifying component 125 may control the detection of the posture and/or gesture of a user's hand. For example, the user identifying component 125 may control posture/gesture detector 122 and/or may control the device 101 (e.g., the user identifying component 125 may control aspects of the device related to posture/gesture control). For example, the user identifying component 125 may determine a level of skill of a user (e.g., based on identification of the user through image analysis and noting the frequency of performance of certain or all postures or gestures) and, based on the level of skill of the user (or based on the frequency of performance of certain or all postures or gestures), may control shape detection algorithms (e.g., algorithms used for hand detection and/or hand posture or gesture recognition) run by the posture/gesture detector 122. For example, the decision of which algorithms to run or the sensitivity of shape detection algorithms run by the posture/gesture detector 122 may be adjusted based on the level of skill of the user.

The device 101 may be any electronic device or home appliance or appliance in a vehicle that can accept user commands, e.g., TV, DVD player, PC, mobile phone, camera, set top box (STB) or streamer, lighting and/or HVAC device, etc. According to one embodiment, device 101 is an electronic device available with an integrated 2D camera.

In one embodiment the device 101 may include a display 11 or a display may be separate from but in communication with the device 101 and/or with the processor 102. According to one embodiment the display 11 may be configured to be controlled by the processor, for example, based on identification of the user.

In FIG. 1B processor 102 may include a posture/gesture detector 122 to detect in the image a predetermined shape of an object, e.g., a user 106 pointing at the camera or, for example, a user or user's hand holding a remote control or other device. The device 101 may then be controlled based on the detection of the predetermined shape.

In one embodiment image sensor 103 which is in communication with device 101 and processor 102 (which may perform methods according to embodiments of the invention by, for example, executing software or instructions stored in memory 12), obtains an image 13 of a user 106 pointing at the image sensor 103 or at the device 101 (or, for example, directing a remote device to the image sensor 103 or to the device 101). Once a user 106 pointing at the image sensor 103 or at the device 101 is detected, e.g., by processor 102, a signal may be generated to control the device 101. According to one embodiment the signal to control the device 101 is an ON/OFF command.

In one embodiment image sensor 103 is part of a ceiling mounted camera and processor 102 may use computer vision techniques to detect a user by detecting a top view of a human, as will be further described below. In some embodiments a first image sensor (e.g., a ceiling mounted camera) may be used for detecting a user and a second image sensor (e.g., a wall mounted camera) may be used to identify the user.

In one embodiment a face recognition algorithm (or another user recognition or identification algorithm) may be applied to image information (e.g., in processor 102 or another processor) to identify the user 106 and generate a command to control parameters of the device 101 (e.g., in processor 102 or another processor) based on the user identity.

For example, a database may be maintained in memory 12 or other memory or storage device associated with the system 100, which links a parameter or set of parameters (e.g., air conditioner temperature, audio device volume, light intensity and/or color, etc.) to users such that each identified user may be linked to a preferred set of parameters.

In some embodiments the system may include a feedback system which may include a light source, buzzer or sound emitting component or other component to provide an indication to the user that he has been detected by the image sensor 103.

The processor 102 may be integral to the image sensor 103 or may be in separate units. Alternatively, the processor may be integrated within the device 101. According to other embodiments a first processor may be integrated within the image sensor and a second processor may be integrated within the device.

Communication between the image sensor 103 and processor 102 and/or between the processor 102 and the device 101 may be through a wired or wireless link, such as through infrared (IR) communication, radio transmission, Bluetooth technology and other suitable communication routes.

According to one embodiment the image sensor 103 may be a 2D camera including a CCD or CMOS or other appropriate chip. A 3D camera or stereoscopic camera may also be used according to embodiments of the invention.

According to some embodiments image data may be stored in processor 102, for example in memory 12. Processor 102 can apply image analysis algorithms, such as motion detection, shape recognition algorithms and/or face recognition algorithms to identify a user, e.g., by recognition of his face and to recognize a user's hand and/or to detect specific shapes of the user's hand and/or other shapes. Processor 102 may perform methods according to embodiments discussed herein by for example executing software or instructions stored in memory 12.

When discussed herein, a processor such as processor 102 which may carry out all or part of a method as discussed herein, may be configured to carry out the method by, for example, being associated with or connected to a memory such as memory 12 storing code or software which, when executed by the processor, carry out the method.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

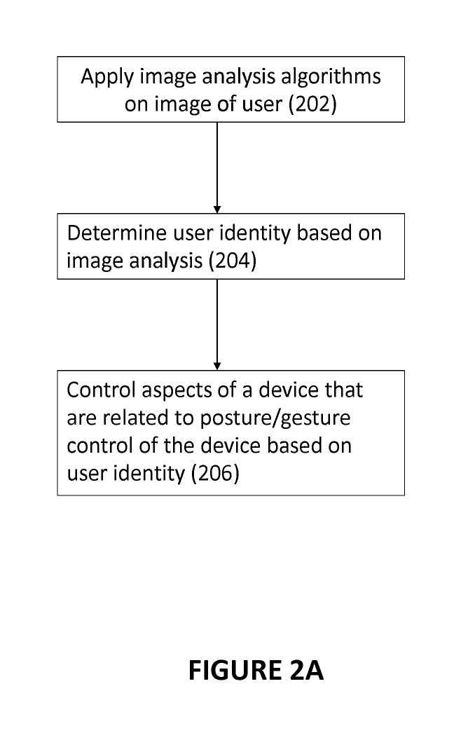

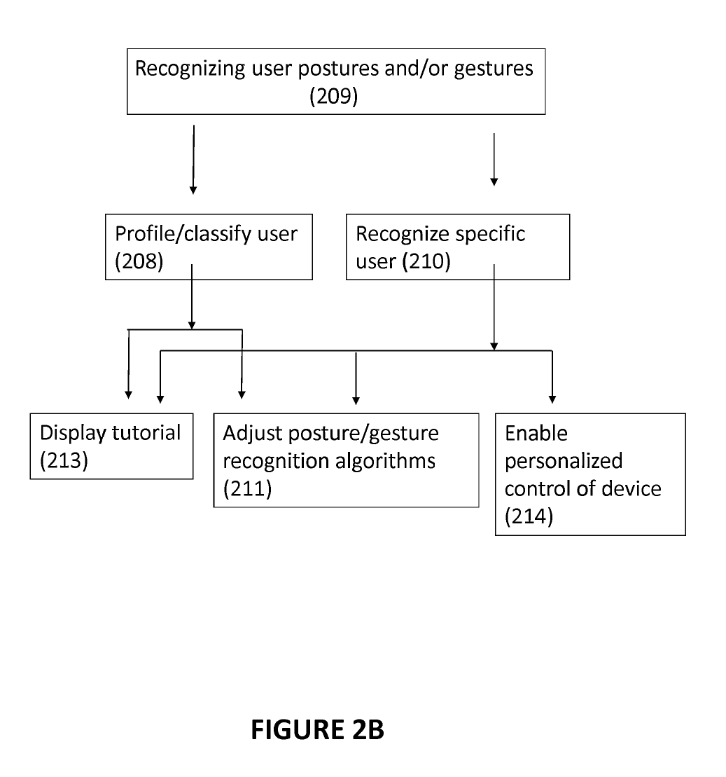

Methods for computer vision based control of a device according to embodiments of the invention are schematically illustrated in FIGS. 2A and B.

According to one embodiment a method for controlling a device includes applying image analysis algorithms on an image of a user (202) and determining the identity of the user based on the image analysis (204). Aspects of a device that are related to posture/gesture control may then be controlled based on the identity of the user (206).

Aspects of the device related to posture/gesture control may include, for example, applications to control a user interface (e.g., display 11) to display posture/gesture control related instructions or hand recognition and/or hand shape recognition algorithms.

Determining the user identity may include recognizing facial features of the user. For example, image information (such as Local Binary Pattern (LBP) features, Eigen-faces, fisher-faces, face-landmarks position, Elastic-Bunch-Graph-Matching, or other appropriate features) may be obtained from an image of a user and facial features may be extracted. Based on the image information (e.g., based on facial features extracted or derived from the image information) a user may be classified or may be specifically recognized based on facial recognition (e.g., by running face recognition algorithms).

In some embodiments recognizing postures and/or gestures of the user's hand may also be used to determine the user identity, as schematically illustrated in FIG. 2B.

Determining the identity of the user may include profiling or classifying the user (208) for example, characterizing the user by gender, by age, by ethnicity or by the user's mood or emotions (e.g., by recognizing an angry/happy/sad/surprised/etc. face). Identifying the user may also include recognizing the user as a specific user (210) (e.g., recognizing specific facial features of the user). Recognition of the user's postures and/or gestures (209) may also be taken into account when identifying a user. For example, recognizing postures or gestures typical of a specific known user may raise the system's certainty of the identity of the specific user.

Control of a device based on the determination of the user's identity from an image (204) and possibly from recognition of the user's postures/gestures (209) may be specific to the “type” of identification of the user (e.g., profiling as opposed to specific user recognition). According to one embodiment a user may be classified or profiled (208), for example, by algorithms run in user identification component 125 that compare features extracted from an image of a user to a database constructed off-line. Identification of the user based on profiling or classification of the user may result in adjustment of the posture/gesture recognition algorithms (211) (run on detector 122, for example). Algorithms may be altered such that posture/gesture recognition may be more or less stringent, for example, based on identification of a user as being above or below a predetermined age or skill of use or may be altered such that specific postures or gestures are more easily recognized based on identification of a user as being from a specific ethnicity or gender.

Classification or profiling a user from image data may be accompanied by recognition of postures and/or gestures of the user. Thus, for example, the system may learn that users from a certain classification or profile have a typical way of performing certain postures or gestures such that classification or profiling of a user may then result in adjustment of posture/gesture recognition algorithms to enable less or more stringent rules for recognizing those postures/gestures.

According to one embodiment, a user may be classified as a “skilled” or “unskilled” user, based, for example, on identification that this user isn't a frequent user and/or based on the frequency of successful postures/gestures performed by this user. According to one embodiment, classification of a user as “unskilled” may cause a tutorial to be displayed (213) on a display (e.g., a monitor of a device that is being used by the “unskilled” user).

Identification of a specific user (210) (as opposed to classification or profiling a user) may also cause adjustment of posture/gesture detection algorithms (211) and/or display of a tutorial (213). Additionally, identification of a specific user (210) may typically enable a more personalized control of a device (214). For example, identification of a specific user (210) (optionally, together with recognition of a pre-determined posture or gesture) may cause automatic log-on and/or display of the user's favorite's menu and/or other personalized actions.

In one embodiment identification of a specific user (210) may enable personalized control of a device such as a lighting or HVAC device or other home or building appliance.

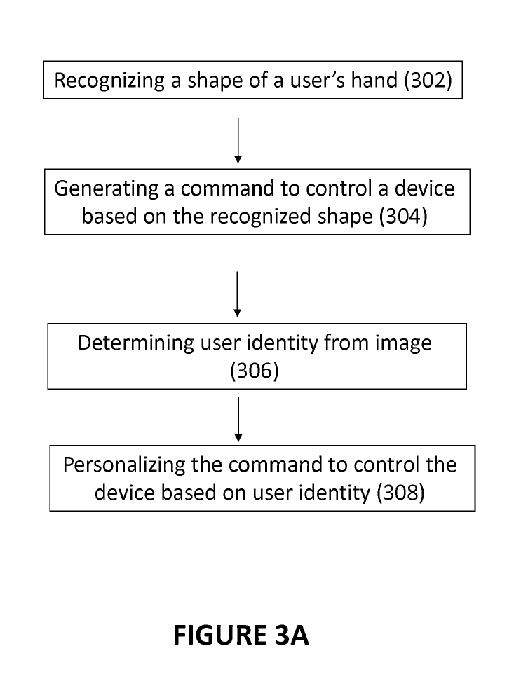

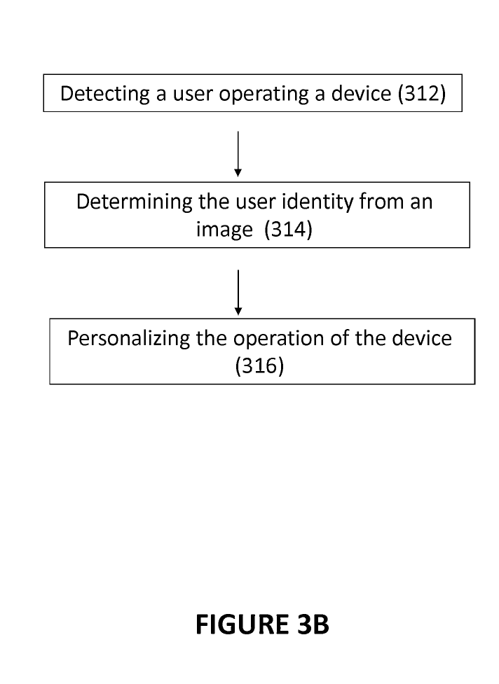

FIG. 3A schematically illustrates a method for controlling a device (e.g., carried out by processor 102) according to embodiments of the invention. According to one embodiment the method includes recognizing a predetermined shape of an object (e.g., a predetermined shape of a user's hand) within a sequence of images (302); generating a command to control the device based on the recognized shape (304); determining the user identity from an image from within the sequence of images (306); and personalizing the command to control the device based on the user identity (308).

FIG. 3B schematically illustrates a method for controlling a device (e.g., carried out by processor 102) according to other embodiments of the invention. According to one embodiment the method includes detecting a user operating a device within a space (312); determining the user identity from an image of the space (314); and personalizing the operation of the device based on the user identity (316).

A user may operate the device using hand postures or gestures, as described herein and a user operating a device within a space (such as a room, building floor, etc.) may be detected by obtaining image information of the space and applying image analysis techniques to detect a predetermined shape (e.g., a predetermined hand posture) from the image information, as described above.

In some embodiments a user may operate the device by pressing a remote control button or manipulating an operating button or switch connected to the device itself. Image analysis techniques such as shape detection algorithms as described herein may be used to analyze a sequence of images of the space to detect a user (e.g., by detecting a shape of a human) as well as to detect other objects and occurrences in the space. In some embodiments a user operating a device may be detected indirectly, e.g., by receiving a signal to operate the device (e.g., the signal being generated by a user pressing an operating button on the device) and detecting a human in a sequence of images which correlates to the signal to operate the device. For example, a signal to operate the device may be received at time t1 and detecting a user operating the device includes detecting a shape of a human in a sequence of images at a time correlating to t1. In another example the user may be detected in a sequence of images at a location in the space which correlates to the location of the device. Thus, for example, the method may include identifying a location of the device in an image from the sequence of images of the space (e.g., the location of the device in the image may be known in advance or object recognition algorithms may be applied on the image to identify the location of the device in the image) and detecting a shape of a human at the location of the device in the image.

A user thus detected (and possibly correlated to operation of the device) may be identified at the time of detection or may be tracked through the sequence of images and identified at a later time. For example, a user may be detected in a first image from a sequence of images but may be identified in a second image in the sequence of images. Thus the method may include tracking a detected user and identifying the tracked user.

Tracking a user in a sequence of images may include receiving a sequence or series of images (e.g., a movie) of a space, the images including at least one object having a shape of a human (the human shape of the object may be determined by known methods for shape recognition), and tracking features from within the object (e.g., inside the borders of the shape of the object in the image) throughout or across at least some of the images. Tracking may typically include determining or estimating the positions and other relevant information of moving objects in image sequences. At some point (e.g., every image or every few images, or periodically), a shape recognition algorithm may be applied at or executed on a suspected or possible location of the object in a subsequent image to detect a shape of a human in that subsequent image. Once a shape of a human is detected at the suspected or possible location features are selected from within the newly detected shape of the human (e.g., inside the borders of the human form in the image) and these features are now tracked.

Detecting a shape of a human may be done for example by applying a shape recognition algorithm (for example, an algorithm which calculates Haar-like features in a Viola-Jones object detection framework), using machine learning techniques and other suitable shape detection methods, and optionally checking additional parameters, such as color or motion parameters.

It should be appreciated that a “shape of a human” may refer to a shape of a human in different positions or postures and from different viewpoints, such as a top view of a human (e.g., a human viewed from a ceiling mounted camera).

Detecting a shape of a human viewed from a ceiling mounted camera may be done by obtaining rotation invariant descriptors from the image. At any image location, a rotation invariant descriptor can be obtained, for example, by sampling image features (such as color, edginess, oriented edginess, histograms of the aforementioned primitive features, etc.) along one circle or several concentric circles and discarding the phase of the resulting descriptor using for instance the Fourier transform or similar transforms. In another embodiment descriptors may be obtained from a plurality of rotated images, referred to as image stacks, e.g., from images obtained by a rotating imager, or by applying software image rotations. Features stacks may be computed from the image stacks and serve as rotation invariant descriptors. In another embodiment, a histogram of features, higher order statistics of features, or other spatially-unaware descriptors provides rotation invariant data of the image. In another embodiment, an image or at least one features map may be filtered using at least one rotation invariant filter to obtain rotation invariant data.

Thus, according to some embodiments a home or building appliance such as a lighting or HVAC device may be turned ON based on detection of a user operating the device and parameters of the device operation may then be controlled based on the user identity. For example, an air conditioning device may be turned on by a user pointing at the device whereas the temperature of the air conditioning device may be set to a predetermined temperature which is the preferred temperature of this specific user.

According to one embodiment the method includes identifying the user's hand (e.g., by applying shape recognition algorithms on the sequence of images) prior to recognizing a shape of the user's hand.

Determining the user identity may include recognizing specific user features (such as facial features of the user) and/or recognizing the user's general characteristics.

Personalizing the command to control the device, may include, for example, a command to enable log-in and/or a command to display a menu and/or a command to enable permissions, and/or a command to differentiate between players and/or other ways of personalizing control of the device, e.g., by controlling parameters of the device operation according to a preferred set of parameters, e.g., as described above.

As discussed above, hand recognition and hand shape or motion recognition algorithms may be differentially activated or may be altered or adjusted based on classification of the user and/or based on specific (e.g., facial) recognition of the user.

According to some embodiments recognition of a specific user (e.g., facial recognition of the user) may control a device in other ways. Identification of a user, typically together with posture/gesture recognition, may enable automatic log-on or display of a menu including the specific user's favorites. In some embodiments identification of a user as a “new user” (e.g., a previously unidentified user) may also control aspects of the display of the device. For example, a “new user interface” may be displayed based on the identification of a previously unidentified user. A “new user interface” may include a tutorial on how to use the device, on how to use posture/gesture control, etc. A “new user interface” may also include a registration form for a new user and other displays appropriate for new users.

In some embodiments, detection of a specific, pre-determined posture or gesture signals a user intentionally using a system (as opposed to non-specific unintentional movements or shapes in the environment of the system). Thus, identification of a user together with the detection of the specific posture or gesture can be used to enable user specific and personalized control of a device.

In some embodiments a predetermined shape, such as a shape of a pointing user or shape of a hand, may be recognized in an image and the user's identity may be determined from that same image. For example, a face may be detected in the same image in which the hand shape was recognized and the user's identity may be determined based on the detection and/or recognition of the face.

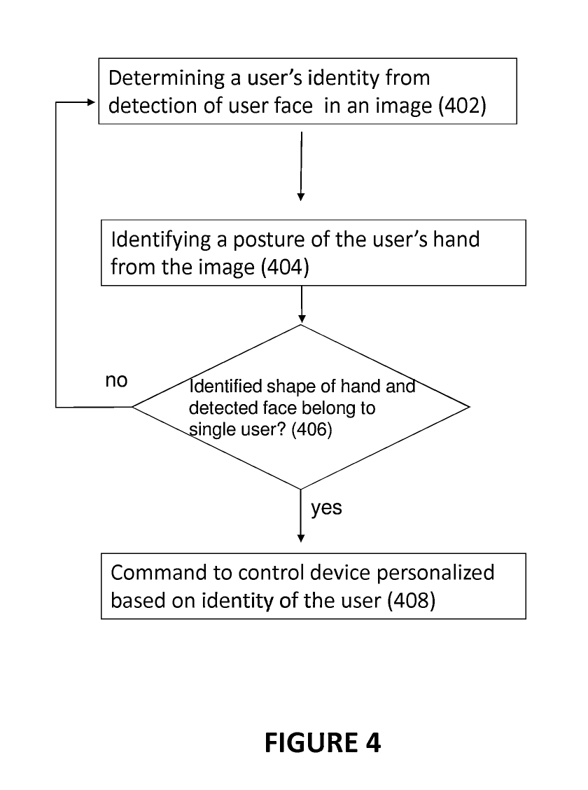

In an exemplary method schematically illustrated in FIG. 4 a user's identity is determined from an image based on image analysis, for example, by a processor running algorithms as described above. A posture and/or gesture of the user's hand is then identified e.g., by a processor running shape detection algorithms, e.g., as described above. Based on the determination of the user's identity and based on the recognized posture and/or gesture, a device may be controlled. For example log-on or permissions may be enabled or specific icons or screens may be displayed, or operation of a device may be according to preferred parameters of the user, for example, as described herein.

The user's identity may be determined, for example, based on detection of the user's face in an image (402). According to some embodiments a shape of a hand (a posture of the hand) is identified in that same image (404) and only if it is determined that the identified shape of the hand and the detected face belong to a single user (the same user) (406) then the command to control the device may be personalized based on the identity of that user (408).

In one embodiment, the shape of the hand may include a shape of a hand holding a remote or other control device.

Determining that the shape of the hand and the face belong to a single user may be done, for example, by determining that the sizes of the hand and face match, that the locations of the hand and face in the image are as expected, e.g., by using blob motion direction and segmentation and/or other methods.

A method according to one embodiment of the invention includes associating an identified user performing a specific gesture or posture with a user profile for security and/or personalization.

According to some embodiments, determination of the user's identity may enable user specific control of a device, such as automatic log-on, based on the determined identity of a user and based on recognition of a pre-determined posture/gesture, enabling specific permissions based on the determined identity of a user, display of a specific screen (e.g., a screen showing the specific user's favorites, etc.), differentiating between players and identifying each player in a game application, etc.

What is claimed is:

1. A method for controlling a device, the method comprising
using a processor to
detect a user operating the device within a space;
determine the user identity from an image of the space; and
personalize operation of the device based on the user identity.

2. The method of claim 1 wherein using a processor to detect a user operating the device within a space comprises detecting a predetermined shape in the image of the space.

3. The method of claim 2 wherein the predetermined shape comprises a pointing user.

4. The method of claim 2 wherein the predetermined shape comprises a predetermined posture of the user's hand.

5. The method of claim 2 wherein the predetermined shape comprises a shape of a human.

6. The method of claim 5 wherein the shape of a human comprises a top view of the human.

7. The method of claim 1 wherein using a processor to detect a user operating the device within a space comprises
receiving a signal to operate the device; and
detecting a human in a sequence of images, the human correlating to the signal to operate the device.

8. The method of claim 7 wherein detecting a human in a sequence of images, the human correlating to the signal to operate the device, comprises
receiving the signal to operate the device at time t1; and
detecting a shape of a human in a sequence of images at a time correlating to t1.

9. The method of claim 7 wherein detecting a human in a sequence of images, the human correlating to the signal to operate the device, comprises
identifying a location of the device in an image from the sequence of images;
and detecting a shape of a human at the location of the device in the image.

10. The method of claim 1 comprising using the processor to track a detected user and identify the tracked user.

11. The method of claim 1 wherein using the processor to determine the user identity from an image of the space comprises recognizing facial features of the user.

12. The method of claim 11 wherein the user identity comprises the user's general characteristics.

13. The method of claim 11 wherein the user identity comprises specific user features.

14. The method of claim 1 wherein using the processor to personalize operation of the device based on the user identity comprises controlling parameters of the device operation according to a preferred set of parameters.

15. A system for computer vision based control of a device, the system comprising
a processor in communication with an image sensor, the processor to detect a user operating the device;
determine the user identity based on image information from the image sensor; and
personalize operation of the device based on the determined user identity.

16. The system of claim 15 wherein the processor is to run a shape detection algorithm to detect a user operating the device.

17. The system of claim 16 wherein the processor is to detect a shape of a human.

18. The system of claim 15 wherein the processor is to apply a face recognition algorithm to the image information to determine the user identity.

19. The system of claim 15 wherein the processor is to track a detected user and identify the tracked user.

20. The system of claim 15 wherein the processor is configured to be in communication with a first image sensor to detect a user and with a second image sensor to identify the user.
